(19) United States
(12) Patent Application Publication
(10) Pub. No.: US 2010/0234157 A1
(43) Pub. Date: Sep. 16, 2010

(54) FIXED SHEAVE FOR STEPLESS TRANSMISSION, METHOD FOR MOUNTING THE FIXED SHEAVE, AND METHOD FOR MANUFACTURING THE FIXED SHEAVE

(75) Inventors: Daisuke Kikukawa, Aichi-ken (JP); Keisuke Ninomiya, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/741,223

(22) PCT Filed: Nov. 4, 2008
(86) PCT No.: PCT/IB08/02948

§ 371 Date: May 4, 2010

(30) Foreign Application Priority Data
Nov. 5, 2007 (JP) 2007-287328

(51) Int. Cl. F16H 55/52; B23P 11/00

(52) U.S. Cl. 474/171; 29/428

(57) ABSTRACT

A fixed sheave is formed by pressing fitting and integrating a sheave portion and a shaft that have been shaped separately. The shaft is formed in a stepwise manner, and has a bearing disposition portion at one end of the shaft and a sheave portion fixing section that has a diameter smaller than that of the bearing disposition portion, and that is on an opposite side of the step from the bearing disposition portion. The sheave portion is fixed to the sheave portion fixing section in abutment, against the step, with a rear surface of the sheave portion facing the one end of the shaft. A finish processing is performed to either or both of the sheave portion and the shaft after the fixing. A first bearing is inserted from the one end of the shaft and disposed at the bearing disposition portion after the finish processing.

### BACKGROUND OF THE INVENTION

1. Field of the Invention

The invention relates to a fixed sheave for a stepless transmission, a method for mounting a fixed sheave, and a method for manufacturing a fixed sheave. More particularly, the invention relates to a fixed sheave for a stepless transmission, a method for mounting a fixed sheave and a method for manufacturing a fixed sheave, configured by integrating a sheave portion and a shaft that have been shaped separately.

2. Description of the Related Art

In a fixed sheave for a stepless transmission, a sheave portion has to be molded at a shaft, but the problem arising when they are integrally molded by forging or the like is that because the outer diameter of the sheave portion is large and the size of the shaft in the axial direction is also large, the productivity is poor. Methods are known for forming the sheave portion formed as a separate body and integrating it with a shaft (for example, Japanese Patent Application Publication No. 2005-69253 (JP-A-2005-69253) (page 6, FIG. 1); Japanese Patent Application Publication No. 2006-105217 (JP-A-2006-105217) (pages 6 to 8, 10, FIGS. 2 and 7).

JP-A-2005-69253 discloses fixing a separately formed sheave portion to a shaft by a key and a key groove, thereby enabling the integral rotation thereof. JP-A-2006-105217 discloses integrating the sheave portion with a shaft by fitting.

Because the sheave portion and the shaft are molded separately, as described hereinabove, the productivity is high, and although the sheave portion is attached to the shaft after molding, a highly accurate fixed sheave can be formed.

However, in this case, distortion of the fixed sheave shape or strains occur after the sheave portion has been attached. For this reason, implementing a finish processing to ensure a final shape accuracy for the entire sheave has been studied. In particular, performing finish process to ensure the accuracy of sheave surface that is important in terms of functional performance of a stepless transmission can be considered.

However, with certain structures of the fixed sheave and assembling procedures, when a sheave portion is attached to the shaft, a bearing is also attached at the same time. In such a case, a bearing is attached to the fixed sheave during the finish processing performed to ensure the shape accuracy. For this reason, fine chips generated during the finish processing penetrate into the bearing, thereby creating a risk of adversely affecting the operation of the stepless transmission having the fixed sheave attached thereto.

### SUMMARY OF THE INVENTION

The invention provides a fixed sheave for a stepless transmission that prevents fine chips from penetrating into a bearing during the finish processing, a method for attaching the fixed sheave for a stepless transmission, and a method for manufacturing a fixed sheave for a stepless transmission.

A fixed sheave for a stepless transmission according to the first aspect of the invention is configured by integrating a sheave portion and a shaft that have been shaped separately. The shaft is formed in a stepwise manner, and has a bearing disposition portion at a first end of the shaft and a sheave portion fixing section that has a diameter smaller than that of the bearing disposition portion, and that is on an opposite side of the step from the bearing disposition portion. The sheave portion is fixed to the sheave portion fixing section in abutment, against the step, with a rear surface of the sheave portion facing the first end of the shaft. A finish processing is performed to either or both of the sheave portion and the shaft after the fixing. After the finishing process, a first bearing is inserted from the first end of the shaft and disposed at the bearing disposition portion after the finish processing, and a second bearing is also disposed at a second end of the shaft opposite to the first end.

The fixed sheave for a stepless transmission is configured by integrating a sheave portion and a shaft that have been shaped separately, but even with such integration, a first bearing can be disposed from a first end at the bearing disposition portion provided at the shaft. Therefore, as well as the first end, it is not necessary to dispose a second bearing at a second end opposite to the first end when the sheave portion and shaft are integrated. As a result, a finish processing can be carried out in a state in which a bearing has not been disposed, after the sheave portion has been fixed to the sheave portion fixing section, and the fixed sheave for a stepless transmission can be configured.

For this reason, even when the fixed sheave for a stepless transmission is used in a stepless transmission, fine chips generated in the finish processing do not penetrate into the bearing and the operation of the stepless transmission can hardly be impeded.

A fixed sheave for a stepless transmission according to the second aspect of the invention is configured by integrating a sheave portion and a shaft that have been shaped separately. The shaft is formed in a stepwise manner, and has a sheave portion fixing section that has a diameter smaller than a first end of the shaft, and that is on an opposite side of the step from the first end of the shaft. The sheave portion has a cylindrical portion that has a thickness in a radial direction equal to or larger than the step and that has an outer peripheral surface formed as a bearing disposition portion, on a rear surface of the sheave portion. The sheave portion is fixed to the sheave portion fixing section with the cylindrical portion of the sheave portion being in abutment against the step. A finish processing is performed to either or both of the sheave portion and the shaft after the fixing. After the finishing process, a first bearing is inserted from the first end of the shaft and disposed at the bearing disposition portion after the finish processing, and a second bearing is also disposed at a second end of the shaft opposite to the first end.

In the above-described second aspect, because the outer peripheral surface of the cylindrical portion in the sheave portion serves as a bearing disposition portion, the size of the fixed sheave in the axial direction can be reduced. Furthermore, the finishing processing may be carried out with respect to the sheave surface

The third aspect of the invention relates to a method for manufacturing a fixed sheave for a stepless transmission configured by integrating a sheave portion and a shaft that have been shaped separately. The manufacturing method includes i) forming the shaft having a step and a sheave portion fixing section that is on an opposite side of the step from a first end, and that has a diameter smaller than that of the first end, ii) fixing the sheave portion to the sheave portion fixing section in abutment, against the step, with a rear surface of the sheave portion facing the first end of the shaft, iii) finish processing either or both of the sheave portion and the shaft, and iv) disposing a first bearing at the first end of the shaft and a second bearing at a second end of the shaft opposite to the first end, after the finish processing.

According to the third aspect, the sheave portion may be press fitted, with the rear surface of the sheave surface facing first end of the shaft, onto the sheave portion fixing section of the shaft till the sheave portion abuts against the step from the second end.

Therefore, fine chips generated in the finish processing carried out to ensure the shape accuracy for the entire sheave do not penetrate into the bearing, and the operation of the stepless transmission having the fixed sheave mounted thereon can hardly be impeded.

In the above-described third aspect, the sheave portion may have a cylindrical portion that has a thickness in a radial direction equal to or larger than the step and that has an outer peripheral surface formed as a bearing disposition portion, on the rear surface of the sheave portion, wherein rollers of a roller bearing as the first bearing disposed between the bearing disposition portion and a case of the stepless transmission roll on the bearing disposition portion. The sheave portion may be fixed to the sheave portion fixing section with the cylindrical portion of the sheave portion being in abutment against the step.

According to the above-described aspect, rollers of a roller bearing as the first bearing disposed between the bearing disposition portion and a case of the stepless transmission roll on the bearing disposition portion. As a result, one end of the fixed sheave for a stepless transmission can be rotatably supported inside the case of the stepless transmission.

The fourth aspect of the invention relates to a fixed sheave for a stepless transmission manufactured by the manufacturing methods according to the third aspect. In the fourth aspect, the finish processing may be carried out to the sheave surface.

Thus, because the sheave surface can be finish processed in a state in which no bearing has been disposed, after the sheave portion and shaft have been assembled, the final shape accuracy of the sheave surface can be ensured for the entire sheave, and fine chips do not penetrate into the bearing during the finish processing of the sheave surface.

According to the aforementioned aspect, in the shaft, a tightening threaded portion for the second bearing disposed between the shaft and the case of the stepless transmission and a bearing fitting portion for fitting the second bearing may be formed in sequence at the second end from the second end toward the first end.

The fixed sheave for a stepless transmission is supported by the first bearing not only at the first end where the bearing disposition portion has been formed, but also supported by the second bearing at the second end. However, in the case where the first end is supported by a roller bearing, the position of the fixed sheave for a stepless transmission in the axial direction has to be also fixed at the second end. For this reason, the threaded portion for bearing tightening and the bearing fitting portion are formed in sequence from a distal end at the second end.

With such a configuration, the bearing fitted by the bearing fitting portion can be tightened to the shaft by screwing a nut on the threaded portion for bearing tightening, and the fixed sheave for a stepless transmission can be rotatably supported, together with the bearing disposed at the bearing disposition portion, inside the case of the stepless transmission.

According to the above-described aspect, the bearing fitting portion may be rotatably supported by a ball bearing as the second bearing while the shaft is fixed in the axial direction.

By thus forming the bearing fitting portion, it is possible to support the fixed sheave for a stepless transmission rotatably, and the position of the fixed sheave for a stepless transmission in the axial direction can be fixed.

The fifth aspect of the invention relates to a method for mounting a fixed sheave for a stepless transmission according to the fourth aspect. In the fifth aspect, the fixed sheave for a stepless transmission according to the fourth aspect may be incorporated in either or both of a secondary sheave and a primary sheave. A ball bearing may be fitted and joined by tightening a nut in a tightening threaded portion to a bearing fitting portion at the second end. The first end of the shaft may be rotatably supported by a case of the stepless transmission by disposing rollers of a roller bearing on the bearing disposition portion, and the second end of the shaft may be rotatably supported, so that the shaft will not be able to move in the axial direction, by fixing the ball bearing to the case of the stepless transmission at the second end.

With such a procedure, the bearings can be attached inside a stepless transmission by disposing and supporting the bearings at both ends of the fixed sheave for a stepless transmission in which the sheave surface has been subjected to finish processing. In the fixed sheave for a stepless transmission, because the bearings are not disposed during the finish processing carried out to ensure the shape accuracy of the sheave surface for the entire sheave, fine chips generated during the finish processing do not penetrate into the bearings. Therefore, the operation of the stepless transmission having mounted thereof either or both of the secondary sheave and primary sheave using the fixed sheave is not inhibited.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein

FIG. 1 is a vertical sectional view of a configuration of a secondary sheave of a stepless transmission of Embodiment 1;

FIG. 2 is a vertical sectional view of a fixed sheave of a stepless transmission of Embodiment 1;

FIG. 3 is likewise a vertical sectional view of parts for illustrating a method for manufacturing a fixed sheave of a stepless transmission of Embodiment 1;

FIG. 4 is a process diagram illustrating a method for mounting a fixed sheave of a stepless transmission of Embodiment 1 inside the stepless transmission;

FIG. 5 is a vertical sectional view of a configuration of a secondary sheave of a stepless transmission of Embodiment 2;

FIG. 6 is a vertical sectional view of a fixed sheave of a stepless transmission of Embodiment 2;

FIG. 7 is likewise a vertical sectional view of parts for illustrating a method for manufacturing a fixed sheave of a stepless transmission of Embodiment 2; and

FIG. 8 is likewise a process diagram illustrating a method for mounting a fixed sheave of a stepless transmission of Embodiment 2 inside the stepless transmission.

### DETAILED DESCRIPTION OF EMBODIMENTS

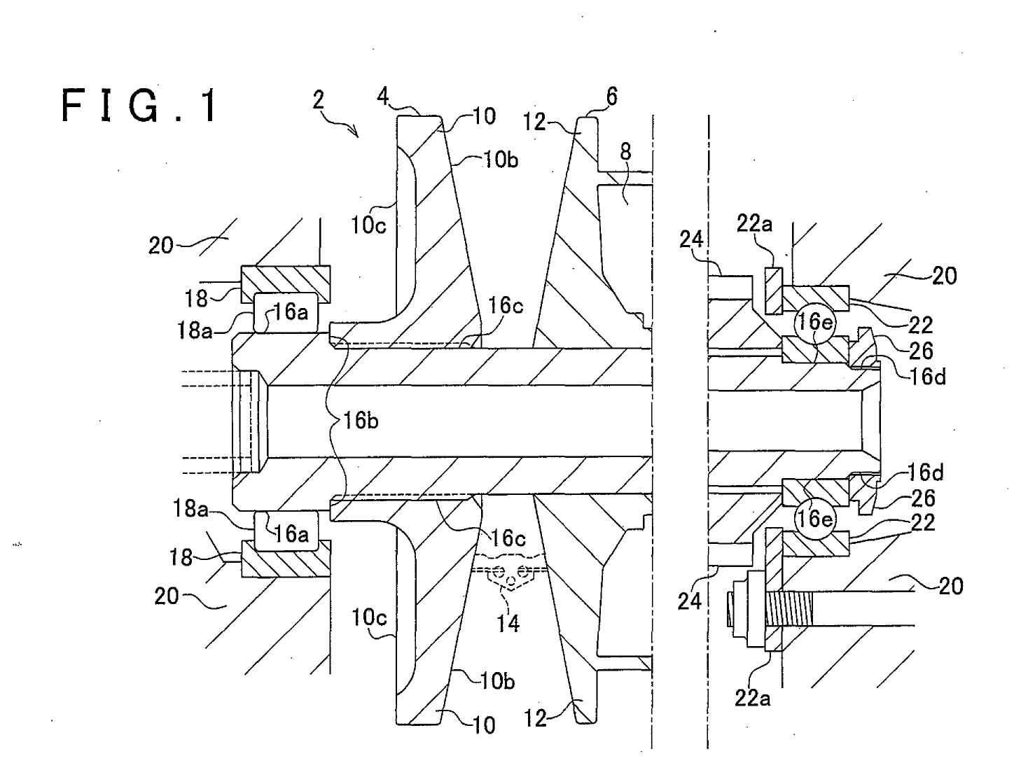

A vertical cross-sectional view in FIG. 1 shows a principal component configuration of a secondary sheave (also called “secondary pulley”) 2 in a stepless transmission of Embodiment 1 of the invention. The secondary sheave 2 includes a fixed sheave 4 and a movable sheave 6. In the secondary sheave 2, a gap between a sheave portion 10 formed by the fixed sheave 4 and a sheave portion 12 formed by the movable sheave 6 is adjusted by an actuator 8 using hydraulic pressure or the like and disposed on the rear surface side of the movable sheave 6. An effective radius of the secondary sheave 2 is thus controlled and the contact position in the radial direction of an endless belt 14 is changed together with that of a primary sheave (also called “primary pulley”), and shifting is implemented.

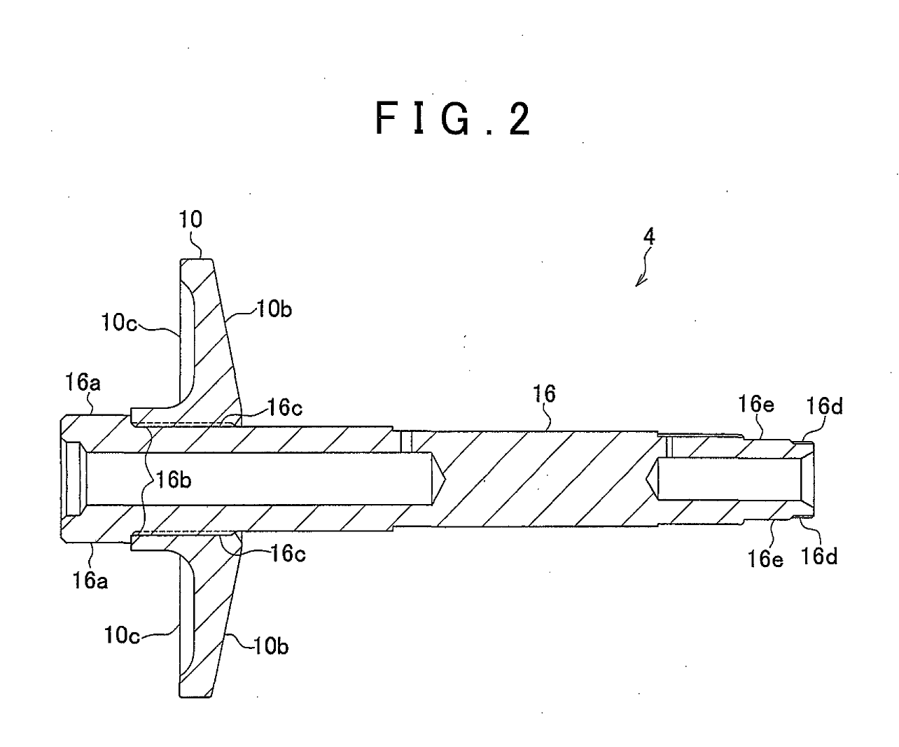

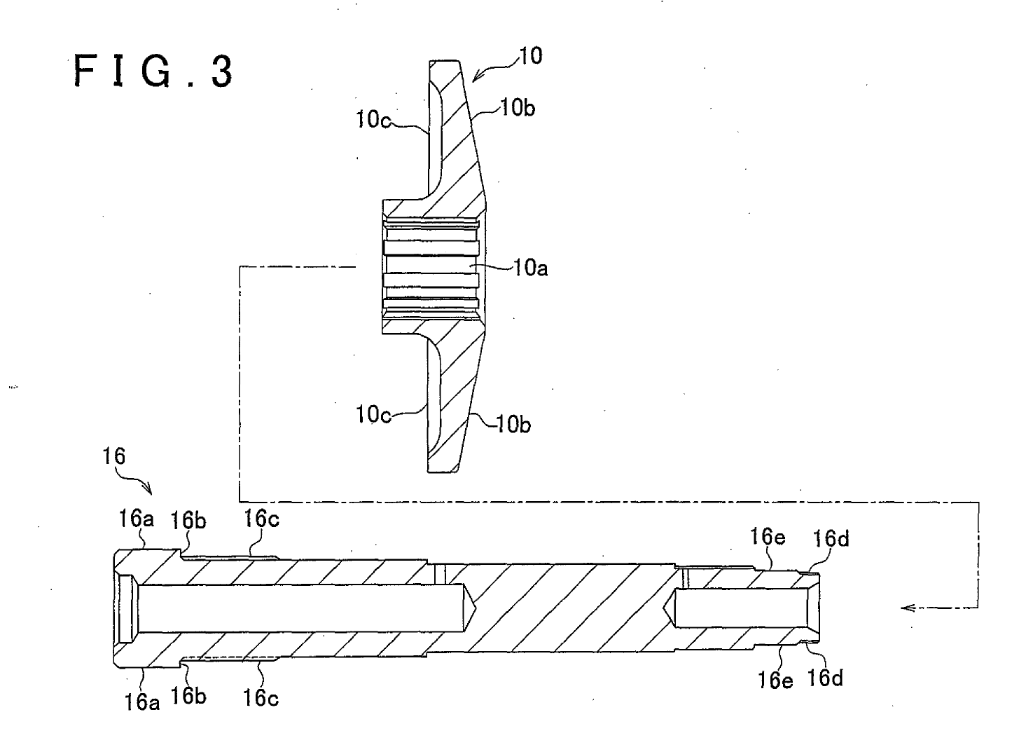

The fixed sheave 4 is formed by assembling and integrating the sheave portion 10 and a shaft 16 as shown in a cross-sectional view in FIG. 2. These sheave portion 10 and shaft 16 are shaped as separate bodies as shown in FIG. 3.

The shaft 16 includes from one end side thereof a bearing disposition portion 16a where a roller 18a of a roller bearing 18 can be disposed and a sheave portion fixing section 16c formed to have a diameter less than that of the one end side by forming a step 16b from the bearing disposition portion 16a.

Further, at the end of the shaft 16 on the side opposite the one end side, a tightening threaded portion 16d for a ball bearing 22 disposed between this portion and a case 20 of a stepless transmission and a bearing fitting portion 16e for fitting the ball bearing 22 are formed in the order of description from a distal end on the opposite side.

The sheave portion 10 and shaft 16 are integrated by inserting the sheave portion 10 from the side of a rear surface 10c toward the one end side (left end side in FIG. 3) of the shaft 16 from the end on the side opposite thereto (right end side in FIG. 3) till the sheave portion abuts against the step 16b, and the sheave portion is fitted and fixed to the sheave portion fixing section 16c as shown in FIG. 2. The fitting and fixing of the sheave portion 10 to the sheave portion fixing section 16c is performed by press fitting. Thus, splines are formed in a central hole 10a of the sheave portion 10 and in the outer periphery of the sheave portion fixing section 16c, and press fitting is performed in a state in which peaks and valleys of the splines are engaged. As a result, the sheave portion 10 is strongly fixed to the shaft 16. In particular the sheave portion is strongly fixed so that sufficient torque transmission is enabled in the rotation direction. Strong fixing by press fitting may be also performed without splines by forming knurls on either of the central hole 10a of the sheave portion 10 and the side of the sheave portion fixing section 16c.

In a state of the fixed sheave 4 integrated as shown in FIG. 2, the sheave surface 10b of the sheave portion 10 is finish processed and shape accuracy of the sheave surface 10b is ensured for the entire fixed sheave 4.

The movable sheave 6 and actuator 8 are then assembled, and press fitting of a gear 24 for torque transmission is implemented. A stopper 22a is inserted on the end portion opposite the bearing disposition portion 16a, and the ball bearing 22 is press fitted by using a bearing fixing portion 16e provided at this end on the opposite side as a press fitting surface. A nut 26 is then screwed onto the threaded portion 16d for tightening and the ball bearing 22 is tightened.

A portion of the bearing disposition portion 16a is then inserted into a central space of a roller 18a arranged at the inner surface of the roller bearing 18 mounted on a case 20 of the stepless transmission, and the roller 18a is placed on the bearing disposition portion 16a. Alternatively, the roller 18a of the roller bearing 18 is disposed in a portion of the bearing disposition portion 16a, whereby the roller bearing 18 is arranged at one end side of the shaft 16, and the shaft 16 is mounted together with the roller bearing 18 on the case 20 of the stepless transmission. As a result, the bearing disposition portion 16a functions as a rolling surface of the roller 18a, and one end side of the secondary sheave 2 is rotatably supported inside the case 20 of the stepless transmission.

As for opposite end of the secondary sheave 2, the side of the case 20 of the stepless transmission is press fitted in a portion of the ball bearing 22, whereby the opposite end is fixed to the case 20 of the stepless transmission via the ball bearing 22. The stopper 22a is then tightened with a bolt to the side of the case 20 of the stepless transmission. As a result, the opposite end is rotatably supported inside the case 20 of the stepless transmission, and the secondary sheave 2 is prevented from moving in the axial direction.

The fixed sheave 4 is thus mounted as part of the secondary sheave 2 on the stepless transmission, and a configuration shown in FIG. 1 is obtained. The following effects are obtained with the above-described Embodiment 1.

(A) The fixed sheave 4 of the present embodiment is configured by integrating the separately shaped sheave portion 10 and shaft 16 in the above-described manner. In the fixed sheave 4 after the integration, the bearings can be disposed on both sides of the sheave portion 10, that is, the roller bearing 18 can be disposed on the bearing disposition portion 16a and the ball bearing 22 can be disposed on the bearing fitting portion 16e.

Therefore, it is not necessary to dispose any of the bearings 18, 22 installed on one side when the sheave portion 10 and shaft 16 are integrated by press fitting. As a result, even when the sheave surface 10b is finish processed to ensure the shape accuracy of the sheave surface 10b over the entire fixed sheave 4 after the sheave portion 10 has been press fitted and fixed to the sheave portion fixing section 16c, the finish processing can be performed in a state in which the bearings 18, 22 are not disposed. Accordingly, the fixed sheave 4 shown in FIG. 2 can be realized.

In the stepless transmission in which the secondary sheave 2 using such fixed sheave 4 is disposed via the bearings 18, 22, fine chips produced by finish processing do not penetrate into the bearings 18, 22. Therefore, the operation of the stepless transmission is not inhibited.

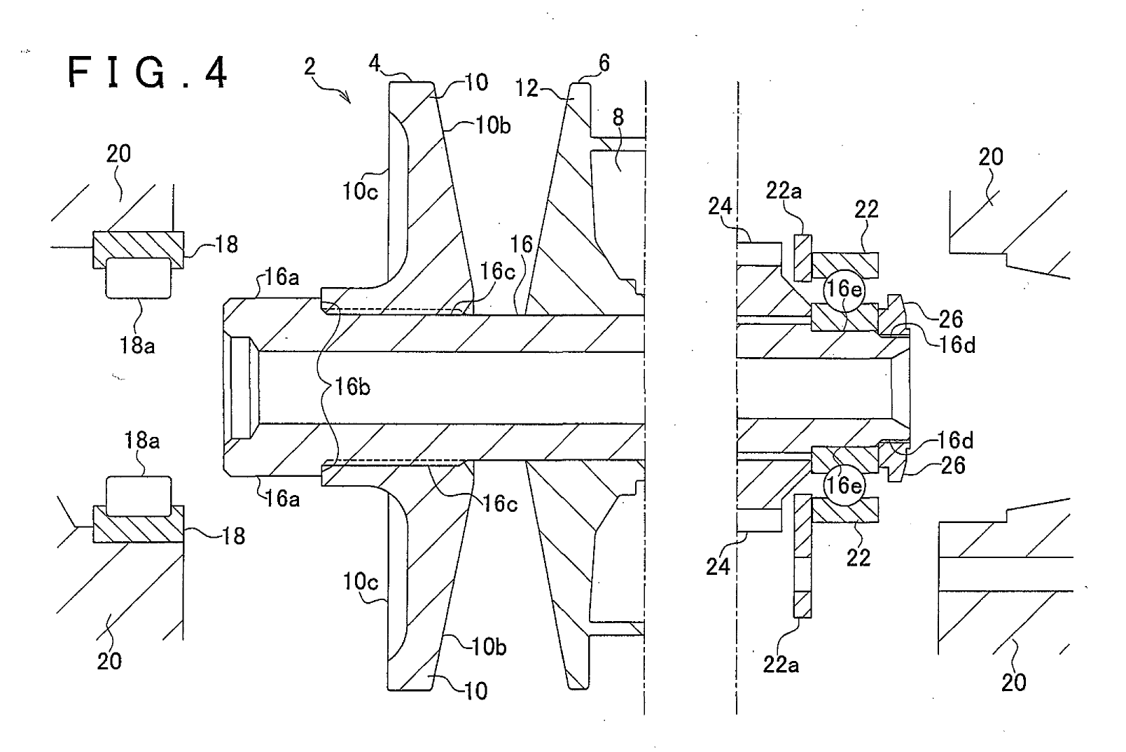

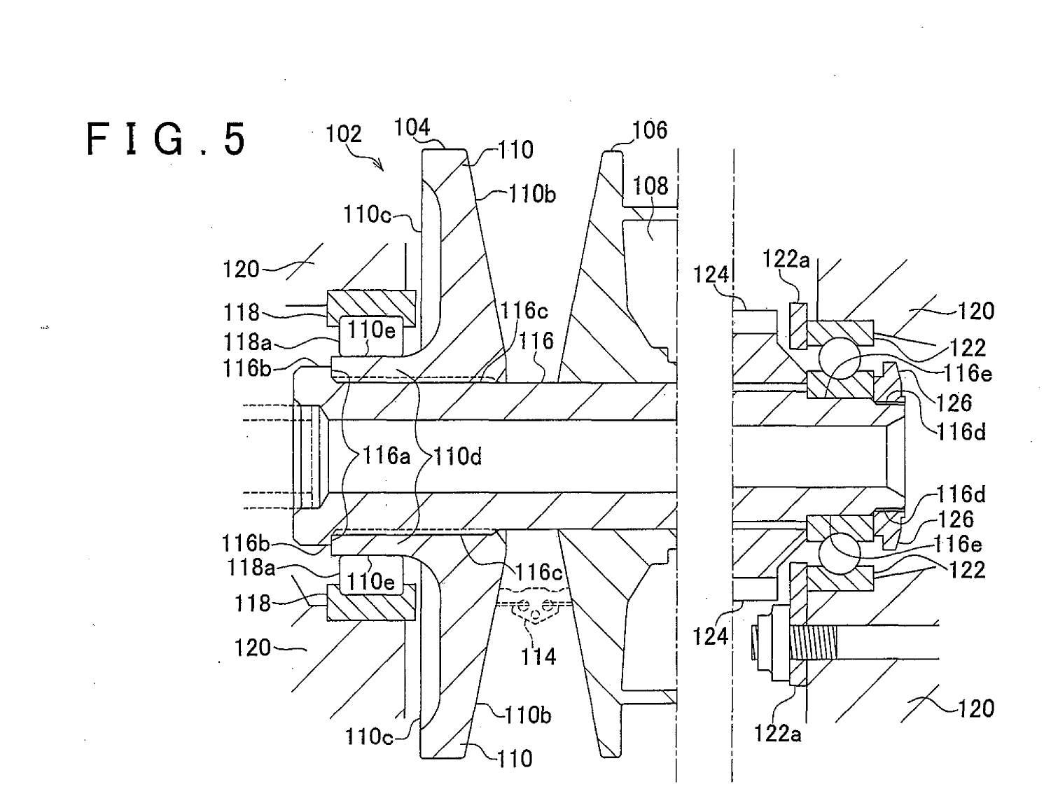

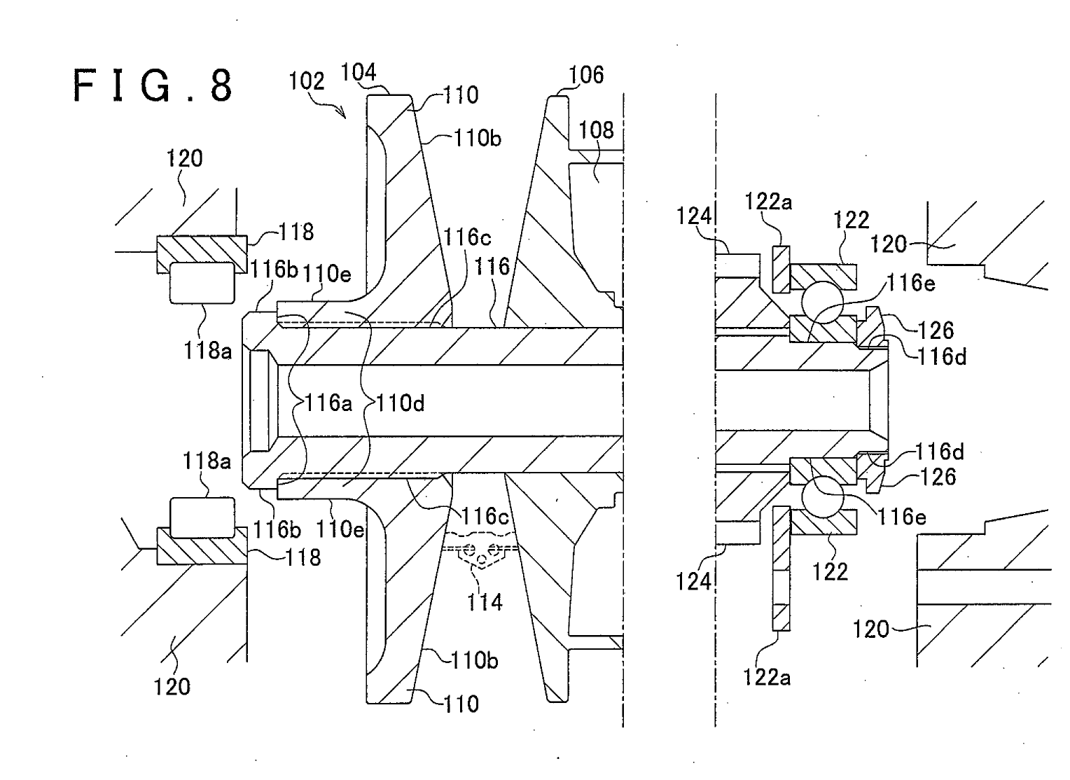

The structural contents of Embodiment 2 that correspond to those of Embodiment 1 shown in FIGS. 1 to 4 are shown in FIGS. 5 to 8. A secondary sheave 102 of the present embodiment, as shown in a principal vertical cross-sectional view in FIG. 5, differs from the secondary sheave of Embodiment 1 in that a roller 118a of a roller bearing 118 is placed on the rear surface side of a fixed sheave 104. Thus, a bearing disposition portion is not provided at a distal end of a shaft 116. In the sheave portion 110, a cylindrical portion 110d that protrudes to the rear surface side is provided in a central portion on the rear surface side of a sheave surface 110b, and the outer peripheral surface of the cylindrical portion 110d serves as a bearing disposition portion 110e.

The diameter of a distal end at one end side (left side in the figure) of the shaft 116 is increased and a step 116a is provided between this portion and a sheave portion fixing section 116c. The sheave portion 110 is press fitted and joined to the sheave portion fixing section 116c in a state in which the sheave portion abuts against the step 116a in the distal end portion of the cylindrical portion 110d. The thickness of the press fitted and joined cylindrical portion 110d in the radial direction is equal to or larger that the step 116a. Therefore, the bearing disposition portion 110c is in the same position in the radial direction as the outermost end of the step 116a or in a position in the radial direction that is higher than the outermost end of the step 116a. As a result, after the sheave portion 110 has been press fitted from the opposite end side (right side in the figure) onto the sheave portion fixing section 116c, the cylindrical portion 110d can be inserted from one end side into a central space between the sheave portion fixing section and the roller 118a of the roller bearing 118, and the roller 118a can be abutted against the bearing disposition portion 110e.

The configurations of a movable sheave 106, an actuator 108, an endless belt 114, a ball bearing 122, a stopper 122a, a gear 124 for torque transmission, and a nut 126 are identical to those of analogous components of Embodiment 1.

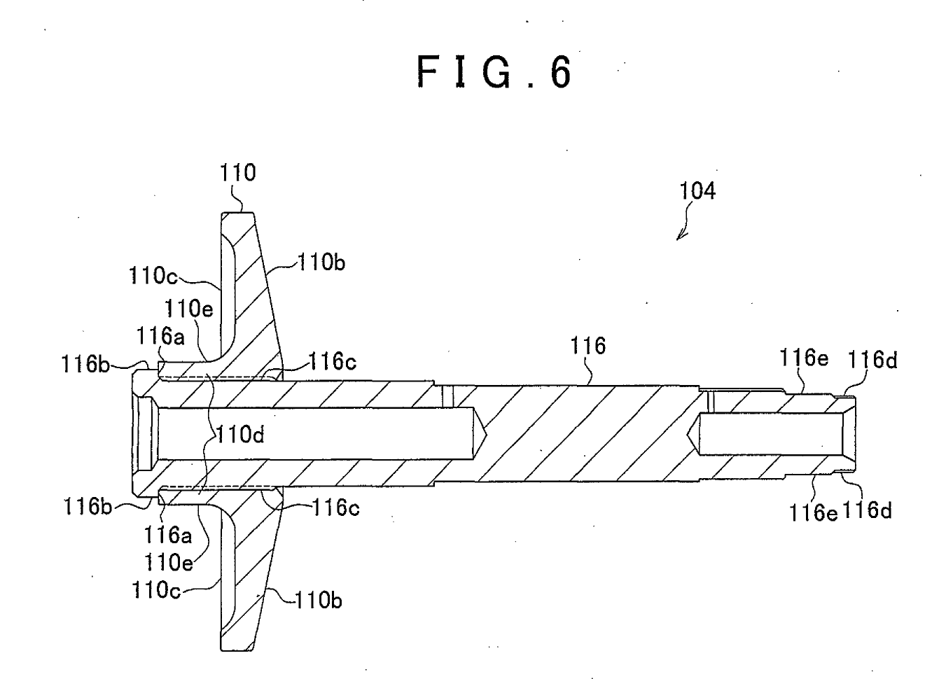

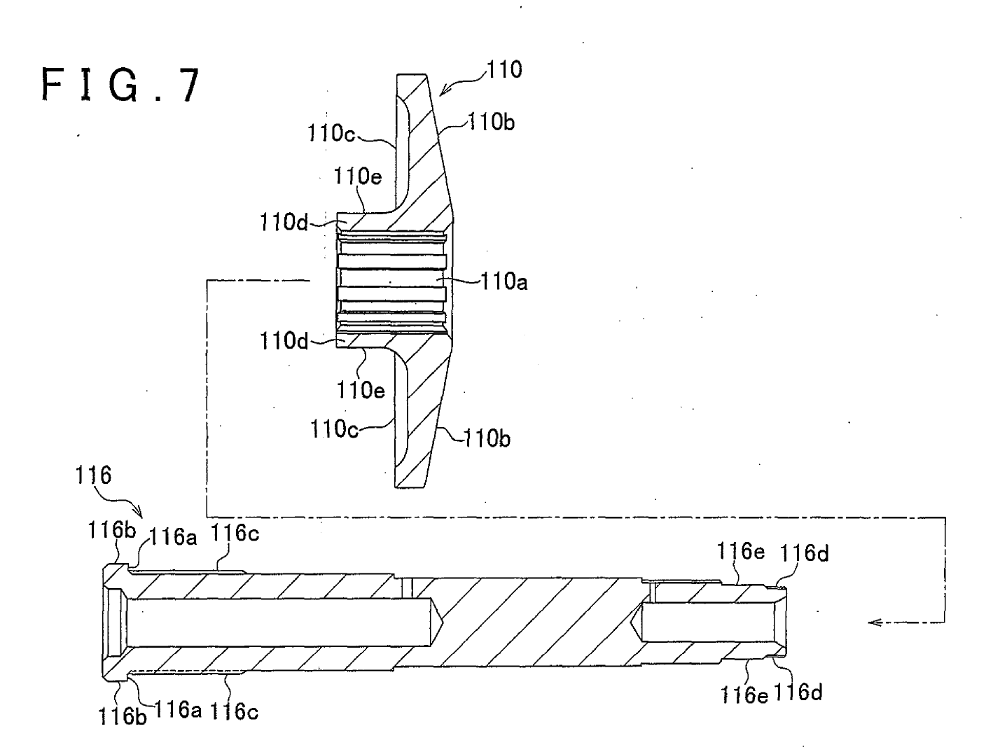

The fixed sheave 104 is formed by assembling and integrating the sheave portion 110 and shaft 116 as shown in a cross-sectional view in FIG. 6. These sheave portion 110 and shaft 116 are formed as separate bodies as shown in FIG. 7.

The above-described step 116a is formed by providing a large-diameter step portion 116b on one end side of the shaft 116, and the sheave portion 110 disposed at the adjacent sheave portion fixing section 116c is press fitted and joined till it abuts against the step 116a at the distal end of the cylindrical portion 110d.

At the end side that is opposite this one end side, a tightening threaded portion 116d for the ball bearing 122 disposed between the shaft and the case 120 of the stepless transmission and a bearing fitting portion 116e for fitting the ball bearing 122 are formed from the distal end of the opposite end side in the same manner as in Embodiment 1.

The sheave portion 110 and shaft 116 are integrated in the following manner. Thus, the sheave portion 110 is inserted toward one end side (left end side in FIG. 7) of the shaft 116 from the end side opposite thereto (right end side in FIG. 7) till the cylindrical portion 110d abuts against the step 116a, and the sheave portion is fitted and fixed to the sheave portion fixing section 116c, as shown in FIG. 6, in a portion of the central hole 110a from the side of the rear surface 110c. The fitting and fixing of the sheave portion 110 at the sheave portion fixing section 116c is performed by press fitting described in Embodiment 1. As a result, the sheave portion 110 is strongly fixed to the shaft 116.

In a state of the fixed sheave 104 integrated as shown in FIG. 6, the sheave surface 110b of the sheave portion 110 is finish processed and shape accuracy of the sheave surface 110b is ensured for the entire fixed sheave 104.

The movable sheave 106 and actuator 108 are then assembled, and press fitting of a gear 124 for torque transmission is implemented. A stopper 122a is inserted on the opposite end side, and the ball bearing 122 is press fitted by using the bearing fitting portion 116e provided at the opposite end side as a press fitting and joining surface. A nut 126 is then screwed onto the threaded portion 116d for tightening and the ball bearing 122 is tightened.

A portion of the bearing disposition portion 110e formed in the outer peripheral surface of the cylindrical portion 110d of the sheave portion 110 is then inserted into a central space of a roller 118a arranged at the inner surface of the roller bearing 118 mounted on a case 120 of the stepless transmission, and the roller 118a is placed on the bearing disposition portion 110e. Alternatively, the roller 118a of the roller bearing 118 is disposed in a portion of the bearing disposition portion 110e, whereby the roller bearing 118 is arranged at one end side of the fixed sheave 104, and the fixed sheave 104 is mounted together with the roller bearing 118 on the case 120 of the stepless transmission. As a result, the bearing disposition portion 110e functions as a rolling surface of the roller 118a, and one end side of the secondary sheave 102 is rotatably supported inside the case 120 of the stepless transmission.

As for opposite end of the secondary sheave 102, the side of the case 120 of the stepless transmission is press fitted in a portion of the ball bearing 122, whereby the opposite end is fixed to the case 120 of the stepless transmission via the ball bearing 122. The stopper 122a is then tightened with a bolt to the side of the case 120 of the stepless transmission. As a result, the opposite end is rotatably supported inside the case 120 of the stepless transmission, and the secondary sheave 102 is prevented from moving in the axial direction.

The fixed sheave 104 is thus mounted as part of the secondary sheave 102 on the stepless transmission, and a configuration shown in FIG. 5 is obtained. The following effects are obtained with the above-described Embodiment 2.

(A) The fixed sheave 104 of the present embodiment is configured by integrating the separately shaped sheave portion 110 and shaft 116 in the above-described manner. In the fixed sheave 104 after the integration, the bearings can be disposed on both sides of the sheave portion 110, that is, the roller bearing 118 can be disposed on the bearing disposition portion 110e and the ball bearing 122 can be disposed on the bearing fitting portion 116e.

Therefore, it is not necessary to dispose any of the bearings 118, 122 installed on one side when the sheave portion 110 and shaft 116 are integrated by press fitting. As a result, even when the sheave surface 110b is finish processed to ensure the shape accuracy of the sheave surface 110b over the entire fixed sheave 104 after the sheave portion 110 has been press fitted and fixed to the sheave portion fixing section 116c, the finish processing can be performed in a state in which the bearings 118, 122 are not disposed. Accordingly, the fixed sheave 104 shown in FIG. 6 can be realized.

In the stepless transmission in which the secondary sheave 102 using such fixed sheave 104 is disposed via the bearings 118, 122, fine chips produced by finish processing do not penetrate into the bearings 118, 122. Therefore, the operation of the stepless transmission can hardly be impeded.

(B) The bearing disposition portion 110e uses the cylindrical portion 110d of the sheave portion 110 that has originally been formed to extend toward the one end side. As a result, the step portion 116b of the shaft 116 serves only to form the step 116a that will be abutted against the sheave portion 110. Therefore, the entire length of the shaft 116 can be reduced and the size of the fixed sheave 104 in the axial direction can be reduced. As a consequence, the stepless transmission incorporating the fixed sheave 104 can be reduced in size and weight.

(a) In the above-described embodiments, the bearing disposition portion 16a, 110e is formed as a rolling surface of the roller 18a, 118a, of the roller bearing 18, 118, but it may also serve as a bearing disposition portion for joining and disposing a ball bearing in the same manner as at the opposite end.

(b) In the above-described embodiments, the sheave portion 10, 110 is fixed to the sheave portion fixing section 16c, 116c of the shaft 16, 116 by press fitting, but other fitting method, for example, welding or joining with a key and a key groove may be performed.

(c) In Embodiment 2, the sheave surface 110b is finish processed after the sheave portion 110 is press fitted to the shaft 116, but finish processing of the bearing disposition portion 110e upon which the roller 118a rolls may be performed before or after the finish processing of the sheave surface 110b. By finish processing the bearing disposition portion 110e in a state in which the bearings 118, 122 are not disposed, after the sheave portion 110 has been press fitted to the shaft 116, it is possible to prevent the fine chips produced during finish processing from penetrating into the bearings 118, 122 in the same manner as in the case of the sheave surface 110b.

(d) Not only the finish processing of the above-described sheave surface 10b, 110b and the bearing disposition portion 110e of the cylindrical portion 110d of Embodiment 2, but also the finish processing of the bearing disposition portion 16a of the shaft 16 of Embodiment 1 can be carried out in a state in which the bearings 18, 22 are not disposed. As a result, fine chips produced during finish processing of the bearing disposition portion 16a do not penetrate into the bearings 18, 22. The same is true for finish processing of other portions.

(e) The above-described embodiments illustrate an example in which the invention is applied to the secondary sheave, but the invention can be also applied to the primary sheave. As a result, the effect described in the embodiments can be also obtained for the primary sheave side.

Furthermore, the invention can be also applied to both the secondary sheave and the primary sheave. As a result, the effects described in the embodiments can be substantially increased.

1. A fixed sheave for a stepless transmission configured by integrating a sheave portion and a shaft that have been shaped separately, wherein
the shaft is formed in a stepwise manner, and has a bearing disposition portion at a first end of the shaft and a sheave portion fixing section that has a diameter smaller than that of the bearing disposition portion, and that is on an opposite side of the step from the bearing disposition portion;
the sheave portion is fixed to the sheave portion fixing section in abutment, against the step, with a rear surface of the sheave portion facing the first end of the shaft;
a finish processing is performed to either or both of the sheave portion and the shaft after the fixing;
a first bearing is inserted from the first end of the shaft and disposed at the bearing disposition portion after the finish processing; and
a second bearing is disposed at a second end of the shaft opposite to the first end after the finish processing.

2. A fixed sheave for a stepless transmission configured by integrating a sheave portion and a shaft that have been shaped separately, wherein
the shaft is formed in a stepwise manner, and has a sheave portion fixing section that has a diameter smaller than a first end of the shaft, and that is on an opposite side of the step from the first end of the shaft;
the sheave portion has a cylindrical portion that has a thickness in a radial direction equal to or larger than the step and that has an outer peripheral surface formed as a bearing disposition portion, on a rear surface of the sheave portion; and
the sheave portion is fixed to the sheave portion fixing section with the cylindrical portion of the sheave portion being in abutment against the step;
a finish processing is performed to either or both of the sheave portion and the shaft after the fixing;
a first bearing is inserted from the first end of the shaft and disposed at the bearing disposition portion after the finish processing; and
a second bearing is disposed at a second end of the shaft opposite to the first end after the finish processing.

3. A method for manufacturing a fixed sheave for a stepless transmission configured by integrating a sheave portion and a shaft that have been shaped separately, comprising:
forming the shaft having a step and a sheave portion fixing section that is on an opposite side of the step from a first end, and that has a diameter smaller than that of the first end;
fixing the sheave portion to the sheave portion fixing section in abutment, against the step, with a rear surface of the sheave portion facing the first end of the shaft;
finish processing either or both of the sheave portion and the shaft; and
disposing a first bearing at the first end of the shaft and a second bearing at a second end of the shaft opposite to the first end, after the finish processing.

4. The method for manufacturing a fixed sheave for a stepless transmission according to claim 3, wherein
the sheave portion is press fitted, with the rear surface of the sheave portion facing the first end of the shaft, onto the sheave portion fixing section of the shaft till the sheave portion abuts against the step from the second end.

5. The method for manufacturing a fixed sheave for a stepless transmission according to claim 4, wherein
the shaft has a bearing disposition portion that is closer to the first end than the step, and on which rollers of a roller bearing as the first bearing disposed between the bearing disposition portion and a case of the stepless transmission roll.

6. The method for manufacturing a fixed sheave for a stepless transmission according to claim 4, wherein
the sheave portion has a cylindrical portion that has a thickness in a radial direction equal to or larger than the step and that has an outer peripheral surface formed as a bearing disposition portion, on the rear surface of the sheave portion, wherein rollers of a roller bearing as the first bearing disposed between the bearing disposition portion and a case of the stepless transmission roll on the bearing disposition portion;
the sheave portion is fixed to the sheave portion fixing section with the cylindrical portion of the sheave portion being in abutment against the step.

7. The method for manufacturing a fixed sheave for a stepless transmission according to claim 3, wherein
the finish processing is carried out to the sheave portion.

8. A fixed sheave for a stepless transmission manufactured by the method according to claim 3, wherein
the finish processing is carried out to the sheave portion.

9. The fixed sheave for a stepless transmission according to claim 8, wherein
in the shaft, a tightening threaded portion for the second bearing disposed between the shaft and the case of the stepless transmission and a bearing fitting portion for fitting the second bearing are formed in sequence at the second end from the second end toward the first end.

10. The fixed sheave for a stepless transmission according to claim 9, wherein
the bearing fitting portion of the shaft is rotatably supported by a ball bearing as the second bearing while the shaft is fixed in the axial direction.

11. A method for mounting a fixed sheave for a stepless transmission, wherein
the fixed sheave for a stepless transmission according to claim 10 is incorporated in either or both of a secondary sheave and a primary sheave;
the ball bearing is fixed and joined by tightening a nut in the tightening threaded portion to the bearing fitting portion at the second end;
the first end of the shaft is rotatably supported by the case of the stepless transmission by disposing rollers of the roller bearing on the bearing disposition portion; and
the second end of the shaft is rotatably supported, so that the shaft cannot move in the axial direction, by fixing the ball bearing to the case of the stepless transmission at the second end.
